(19) United States
(12) Patent Application Publication
(10) Pub. No.: US 2005/0224501 A1
(43) Pub. Date: Oct. 13, 2005

(54) Thermal storage container

(76) Inventors: Rod Folkert, Holland, MI (US); Robert Johnston, Holland, MI (US)

Correspondence Address: MILLER, CANFIELD, PADDOCK AND STONE, P.L.C., Suite 2500, 150 West Jefferson, Detroit, MI, 48226, US

(21) Appl. No.: 11/101,715

(22) Filed: Apr. 8, 2005

Related U.S. Application Data
(60) Provisional application No. 60/561,004, filed on Apr. 9, 2004.

(51) Int. Cl. F25D 3/08; B65D 81/38; A47J 39/00; A47J 41/00; B65D 83/72

(52) U.S. Cl. 220/592.2

(57) ABSTRACT

A thermal storage container is disclosed highly useful for storing items at or below a desired temperature for a predetermined period of time. The thermal storage container comprises an outer box, an insulating box positioned within the outer box, wherein the insulating box has at least one wall having a thickness, and an inner box, wherein the insulating box surrounds the inner box. An outer carton can be positioned around the outer box. An interference fit can be held between the inner box and the insulating box, the insulating box and the outer box, and/or the outer box and the outer carton, and the boxes are removable from one another. At least one layer of tape can be wrapped around the insulating box.

### RELATED APPLICATION

This application is claims priority benefit of U.S. provisional patent application No. 60/561,004 filed on Apr. 9, 2004.

### FIELD OF INVENTION

This invention pertains to thermal storage containers for temporary storage of perishable items, and more particularly to edible frozen or chilled food stuffs, perishable floral items, perishable frozen or chilled medical, pharmaceutical and biological products and other items which must be kept frozen or chilled over a period of time.

### BACKGROUND OF THE INVENTION

Containers can be used for shipping. Some items, such as frozen foods, some medical, pharmaceutical and biological products, and floral items, need to be maintained in a controlled thermal state for extended periods of time while being shipped. Conventional containers for chilled items typically require the use of surrounding external refrigerant such as dry ice or frozen gel packs, for example. Also, some conventional containers must be stored in a refrigerated cooler or freezer, and often transported via a refrigerated mode of transportation, such as, for example, a refrigerated truck or train. Such measures for storing and transporting chilled or frozen items in conventional containers are expensive and inconvenient, and can be hazardous for users.

Known containers include U.S. Pat. No. 2,927,720 to Adams. Adams discloses a portable insulated container with insulation on 6 sides. However, the container disclosed in Adams uses fiberglass for insulation. Such material selection would be commercially unacceptable near foodstuffs. Also, the insulation does not entirely surround the interior of the container, as frame (non-insulating) members extend from the interior of the box to its exterior. Further, the inner portion of the container is not removable from the outer container, and there is nothing in Adams which teaches or suggests holding a low temperature for the extended periods of time required with modern packaging and transportation. Known containers also include U.S. Pat. No. 2,590,724 to Ruthven et al. Ruthven, however, only shows a box having insulation on 5 sides and like Adams, frame members extend from the interior to the exterior of the container, and the inner portion is not removable from the outer portion.

Coolers are commonly used to store food and beverage items that must be kept at low temperatures to prevent spoilage. Coolers are available in various sizes and shapes from the large hard-sided insulated chests to the individual soft-sided lunch sacks. These coolers are designed for the sole purpose of keeping perishable foodstuffs cold or frozen. Coolers generally have walls defining an interior cavity into which the foodstuff is placed. The walls are usually made of or contain an insulating material such as foam or air. These containers used to keep various chilled and frozen items cold or frozen include the so-called Styrofoam® or EPS (encapsulated polystyrene) cooler, (white, molded) or “picnic coolers,” large hard-sided insulated chests, made of blow molded plastic or metal. These coolers also need a coolant, typically wet ice, in the form of cubes or blocks of ice, made with water, although dry ice and gel packs could be used. Boxes that can be carried may require as much as 10-20 lbs. of dry ice to keep the items in the box chilled to a below a predetermined temperature.

Some chilled or frozen products are placed in a cooler alone (without a phase changer). Typically these items will stay frozen for seven (7) hours or less. This amount of time is unacceptable for many commercial applications. Moreover, such coolers are relatively heavy and bulky. This takes up space in warehouses and freezers. Further, high weight increases transportation costs, especially when large amounts of chilled items are to be shipped over large distances, as is typical with foodstuffs today. Thus, coolers are not desired for use in shipping of chilled items. To date, there are no thermal storage containers that can hold a temperature for chilled items for a commercially acceptable period of time without the use of dry ice or gel packs. It would be highly desirable to provide thermal storage containers to maintain an item at a low temperature for an extended period of time that do not require extra coolants and that remedy the aforementioned complications associated with conventional containers.

### SUMMARY OF THE INVENTION

In accordance with a first aspect, a thermal storage container is disclosed for storing items at or below a desired temperature for a predetermined period of time comprising, an outer box, an insulating box positioned within the outer box, wherein the insulating box has at least one wall having a thickness, and an inner box, wherein the insulating box surrounds the inner box, and the insulating box has an R value of at least 4 per inch of thickness of wall. An outer carton can be positioned around the outer box. In accordance with another aspect, an interference fit is produced between the inner box and the insulating box, the insulating box and the outer box, and/or the outer box and the outer carton, and the boxes are removable from one another. In accordance with another aspect, at least one layer of tape can be wrapped around the insulating box.

From the foregoing disclosure and the following more detailed description of various preferred embodiments, it will be apparent to those skilled in the art that the present invention provides a significant advance in the technology of thermal storage containers. Particularly significant in this regard is the potential the invention affords for providing a high quality, low cost thermal storage container capable of keeping items chilled or frozen for extended periods of time. Additional features and advantages of various preferred embodiments will be better understood in view of the detailed description provided below.

### BRIEF DESCRIPTION OF THE DRAWINGS

FIG. 1 is a perspective view of a thermal storage container in accordance with a preferred embodiment shown in a closed position.

FIG. 2 is an exploded perspective view of the thermal storage container of FIG. 1 showing four boxes (outer carton, outer box, insulating box, and inner box) nested together.

FIG. 3 is a perspective view of the insulating box shown with the underside of a lid and a gasket visible.

FIG. 4 is an isolated perspective view of an alternate preferred embodiment, showing the lid wall formed as two separate pieces.

FIG. 5 is an unfolded view of the outer carton.

FIG. 6 is an unfolded view of the outer box.

FIG. 7 is an unfolded view of the inner box.

FIG. 8 is an isolated, assembled view of the insulating box.

It should be understood that the appended drawings are not necessarily to scale, presenting a somewhat simplified representation of various preferred features illustrative of the basic principles of the invention. The specific design features of the thermal storage container as disclosed here, including, for example, the specific dimensions of the insulating box, will be determined in part by the particular intended application and use environment. Certain features of the illustrated embodiments have been enlarged or distorted relative to others to enhance visualization and clear understanding. In particular, thin features may be thickened, for example, for clarity of illustration. All references to direction and position, unless otherwise indicated, refer to the orientation illustrated in the drawings.

### DESCRIPTION OF CERTAIN PREFERRED EMBODIMENTS

It will be apparent to those skilled in the art, that is, to those who have knowledge or experience in this area of technology, that many uses and design variations are possible for the thermal storage containers disclosed herein. The following detailed discussion of various alternative and preferred features and embodiments will illustrate the general principles of the invention with reference a thermal storage container suitable for use with perishable foodstuffs. Other embodiments suitable for other applications will be apparent to those skilled in the art given the benefit of this disclosure.

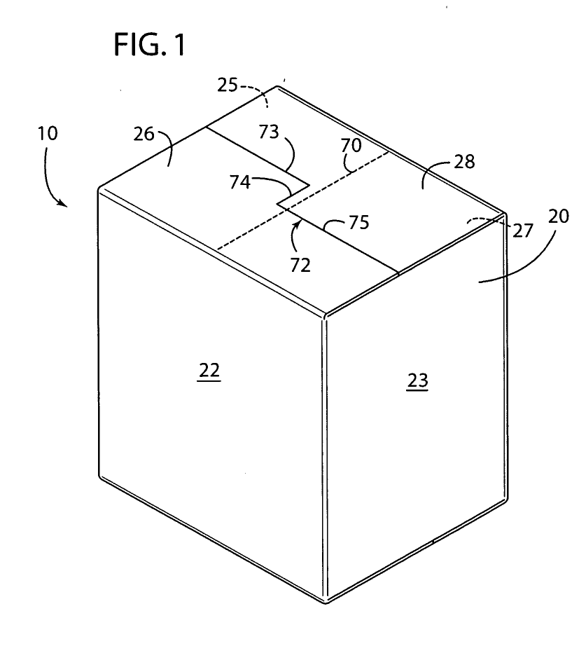

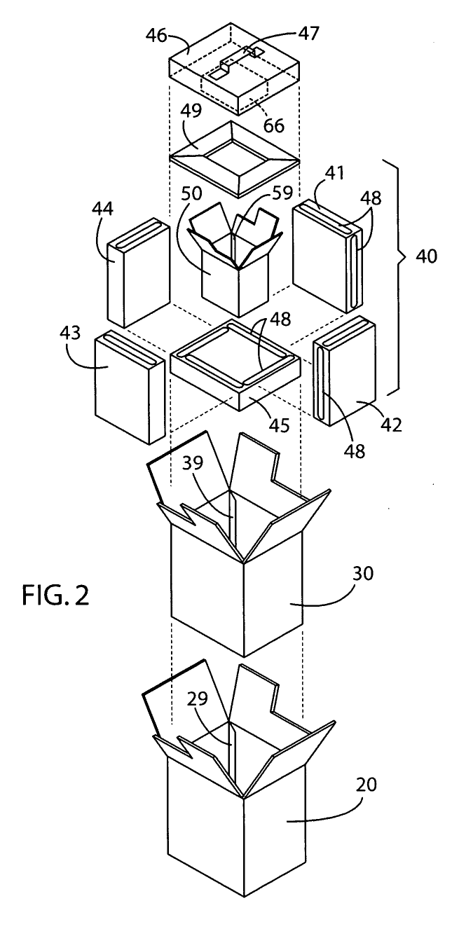

Turning now to the drawings, FIG. 1 shows a perspective view of a thermal storage container 10 shown assembled and closed in accordance with a preferred embodiment. Only the outer carton 20 is visible in FIG. 1. Preferably the thermal storage container 10 comprises three and most preferably four nested boxes: exterior or outer carton 20, an outer box 30, insulating box 40, and inner box 50 (See FIG. 2). Nested is understood to mean here that a folded box is positioned entirely within the interior space defined by a folded and closed larger box. In the embodiment shown in the drawings the inner box 50, outer box 30 and outer carton are preferably made from corrugated cardboard. Most preferably, inner box 50 and outer box 30 are cascaded. That is, each box 30 and 50 has a wax coating which helps reduce air flow (and resultant heat transfer into the inner box) and also advantageously restricts moisture.

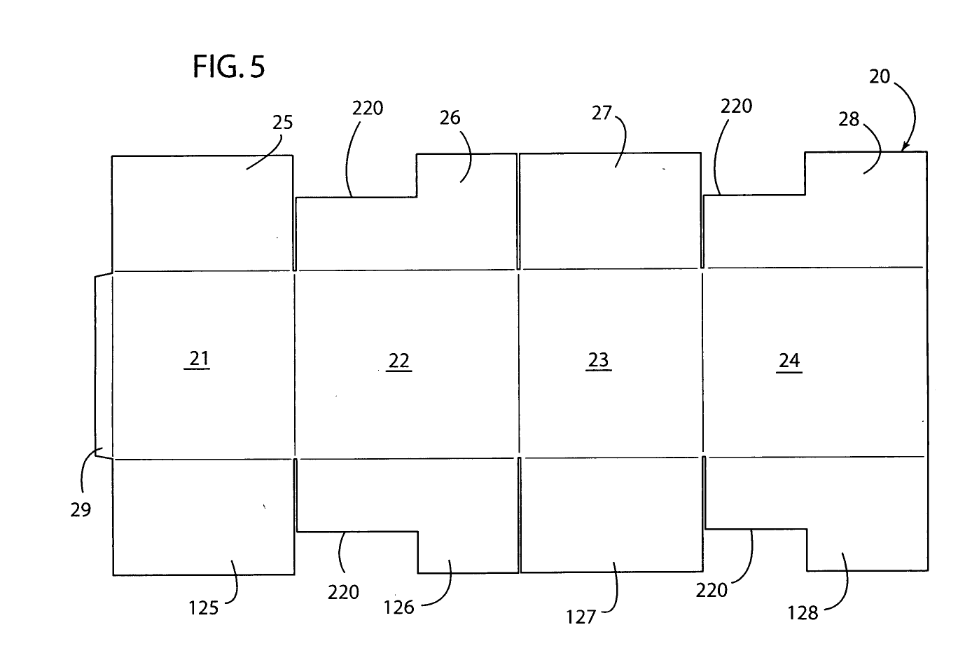

Preferably each box 20, 30 and 50 is “dustproof” as that term is understood by those skilled in the art of packaging. That is, the cardboard boxes having small openings with tight tolerances so that it is very difficult for dust and/or even air to enter each of the boxes. In particular, as shown in FIGS. 5-7, unfolded outer carton 20, outer box 30 and inner box 50 all have narrow slots between flaps. For example, in FIG. 5, unfolded outer carton 20 has four sides 21-24 and a flange 29 which cooperate to form four closed side walls of the carton once folded into an assembled shape. Each side has a corresponding pair of flaps, for a total of eight flaps. Flaps 25-28 cooperate to form a top wall of the outer carton 20, and flaps 125-128 cooperate to form a bottom wall of the outer carton. Preferably two flaps define notches 220 to form an irregular or jogged meeting between flaps 26 and 28 (See FIG. 1).

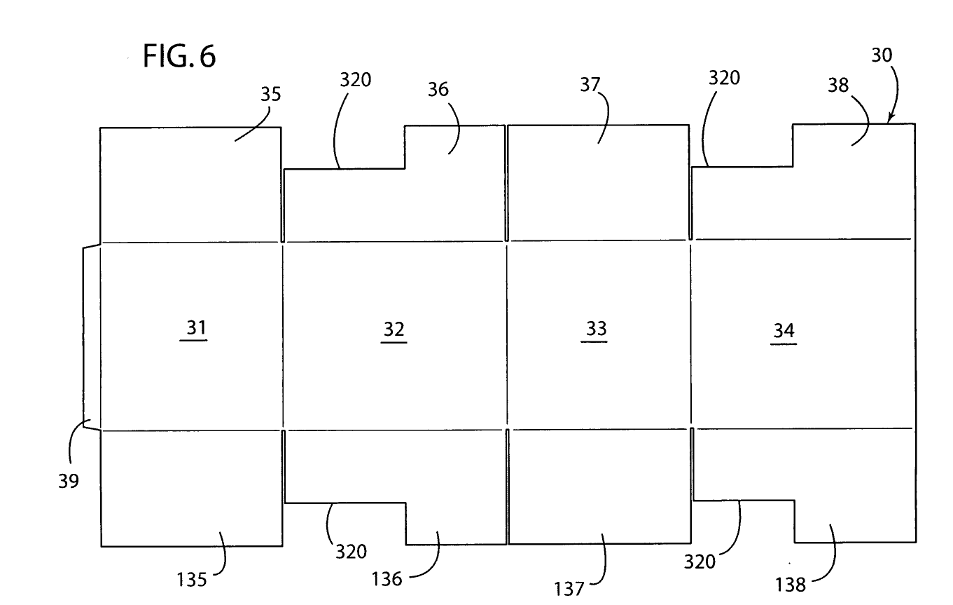

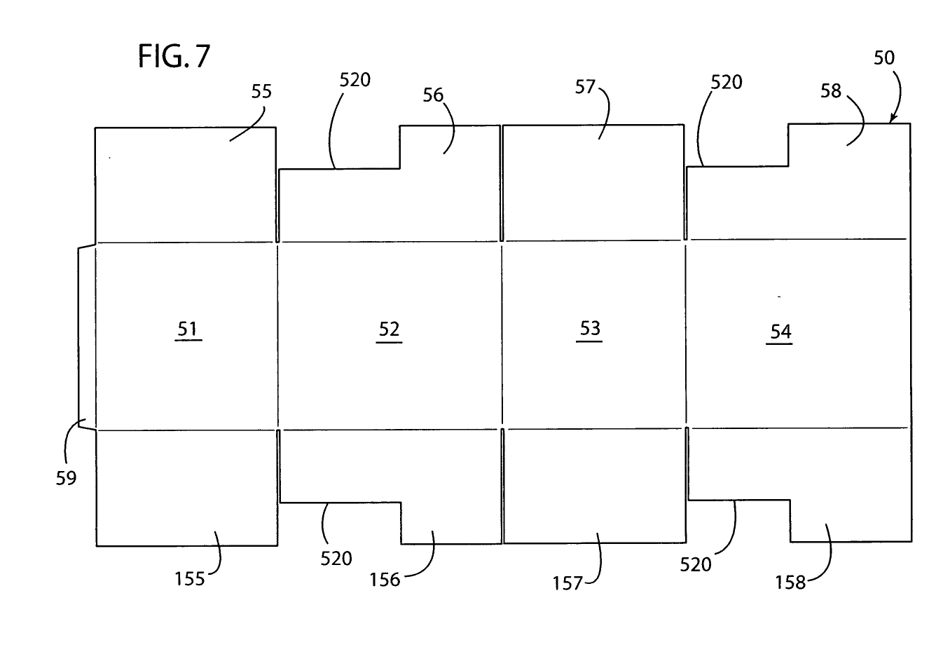

Preferably outer box 30 and inner box 50 are formed in an analogous manner. In FIG. 6, unfolded outer box 30 has four sides 31-34 and a flange 39 which cooperate to form four closed side walls of the outer box once folded into an assembled shape. Each side has a corresponding pair of flaps, for a total of eight flaps. Flaps 35-38 cooperate to form a top wall of the outer box 30, and flaps 135-138 cooperate to form a bottom wall of the outer box. Preferably two flaps define notches 320 to form an irregular or jogged meeting between flaps 36 and 38. In FIG. 7 unfolded inner box 50 has four sides 51-54 and a flange 59 which cooperate to form four closed side walls of the inner box once folded into an assembled shape. Each side has a corresponding pair of flaps, for a total of eight flaps. Flaps 55-58 cooperate to form a top wall of the inner box 50, and flaps 155-158 cooperate to form a bottom wall of the outer box. Preferably two flaps define notches 520 to form an irregular or jogged meeting between flaps 56 and 58.

Preferably each box 20, 30, and 50 has irregular meeting lines for the corresponding flaps. For example, in FIG. 1, the folded and closed outer carton 20 has flaps 25 and 27 which meet at meeting line 70, and flaps 26 and 28 which meet at meeting line 72. Meeting line 70 is straight. Meeting line 72 is jogged, with straight portions 73 and 75 spaced apart from portion 74. Meeting line portion 74 is offset from meeting line 72. Thus, the offset meeting lines help square up the box and make it more difficult for air and dust to penetrate inside the box.

Boxes 20, 30 and 50 are shown folded but with the top wall open in FIG. 2. Tape or other suitable fastening device may be used to hold the box folded. In accordance with a highly advantageous feature, the boxes are reusable. That is, the boxes are removable from one another. For example, if the outer carton is damaged, it can be replaced and the outer box-insulating box-inner box combination may be inserted into a new outer carton.

In addition, preferably outer box 30 has an interference fit with the outer carton 20. Boxes made of corrugated cardboard are resiliently deformable, so box 30 may be positioned entirely within outer carton 20 even when sized to be slightly larger than the interior space defined by outer carton 20. An interference fit, or more broadly, at least a snug fit (where at least one pair of the side walls of one box form an interference fit with a pair of side walls of another box) is desirable in reducing air flow and resultant heat transfer from one box to another. Thus, preferably there is also an interference fit or snug fit between the outer box 30 and the insulating box 40, and between the inner box 50 and the insulating box 40.

The insulating box 40 advantageously is not only resistant to heat transfer but is also water resistant. The bottom side of the inner box 50 may be closed and taped shut. The top side of the inner box 50 may also be taped shut. The inner box 50 may be easily packed with the chilled or frozen product, and stored under refrigerated or freezer conditions, well in advance of shipping, and then, just prior to shipping, placed in the outer box and outer carton. This makes packing convenient for the primary user. The present invention provides for a removable inner box and insulating box. By being removable, the inner box may also be removed upon arrival at the end user and placed in either a refrigerator (chilled contents) or a freezer (frozen contents).

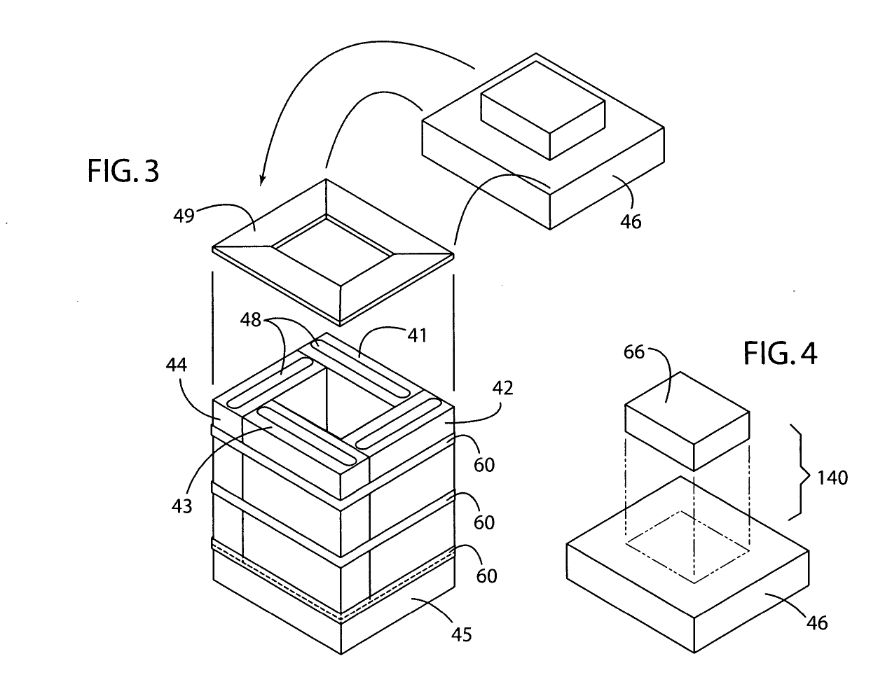

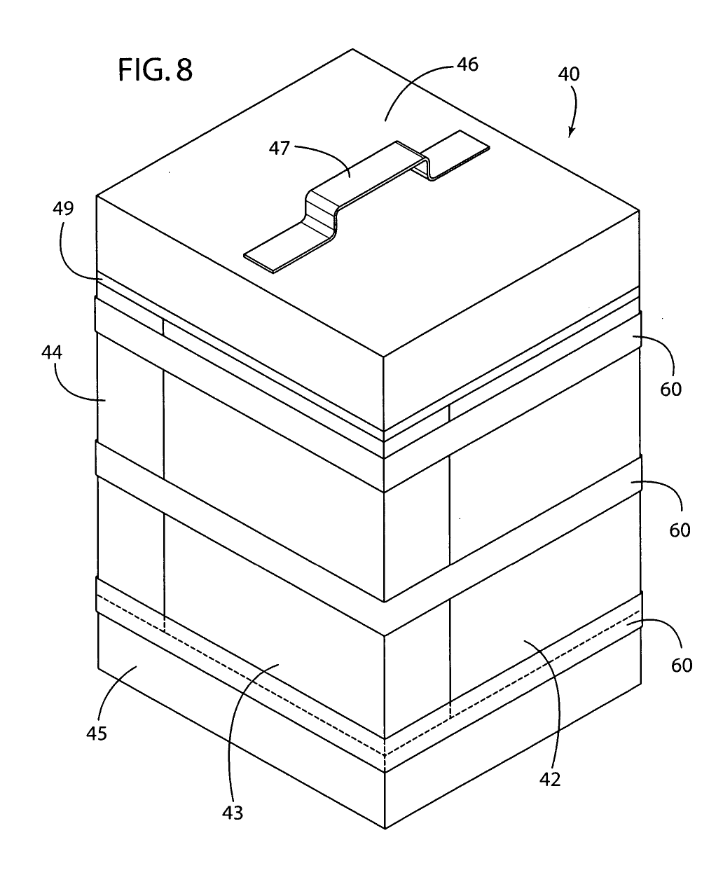

The insulating box is shown in FIG. 2 to have four side walls 41-44, a bottom wall 45 and a lid wall 46. Preferably each of the side walls 41-44 is formed identical in construction, formed as a rectangular solid. The bottom wall 45 is also formed as a rectangular solid. In accordance with a highly advantageous feature, the four side walls can be sealed together and to the bottom wall 45 at right angles to each other, using a sealant 48. The sealant 48 can comprise, for example, glue, hot melt adhesive, ultrasonic fastening, caulk, sealant or tape which can handle the stress of shipping and which remains pliable at very low temperatures (below 0° F.). One example of a suitable hot melt adhesive suitable for use with foodstuffs which maintains its adhesive properties under the extreme cold temperatures expected to be routinely encountered by the thermal storage containers is hot melt adhesive HM 717 supplied by Industrial Adhesives of Indiana. Top lid wall 46 may be formed from a single piece, as shown in FIGS. 2 and 3, or as two pieces, with bottom piece 66 formed separately to form a two piece lid wall 146 shown in FIG. 4. When formed as two pieces, they may be adhesively bound to one another using the sealant 48, or otherwise attached together. A handle 47 is attached to the lid wall 46. The handle 47 may comprise, for example, a polyvinyl tape over printed paper attached with adhesives to the insulating box 40 (FIG. 8).

A gasket 49 is used to help form a tighter seal between the lid wall and the side walls. Gasket 49 is either attached to the lid wall or, as shown in FIGS. 2 and 3, attached to the top sides of the side walls 4144 with a sealant. The gasket may be formed as four separate segments with rabbeted edges which meet at 45° angles formed around a rabbeted edge. Gasket 49 may be formed from a polyvinyl chloride foam sealant with pressure sensitive adhesive on one side such as Norseal® supplied by Norton Plastics of New York.

The insulating box walls 41-46 preferably comprise an insulating material such as extruded polystyrene, such as Styrofoam®, a product of Dow Chemical Company. Other insulating materials suitable for use as the frame members comprise, for example, Owens Corning's polystyrene, encapsulated polystyrene (EPS), fiberglass insulation and other synthetic (such as aerogel) insulating materials. Generally it is desirable to use insulating walls having an R value of at least 4 per inch, and more preferably at least 5/inch. As used herein, R-value refers to a measure of insulating power or ability to resist the flow of heat, expressed as an R value per inch, such as R equals 5/inch, or more simply, R=5. Higher R-values mean greater insulating power. Non-insulating material is one with a very low or negligible R value, such as corrugated cardboard.

The insulation materials used in the walls 41-46 serve to not only provide resistance to thermal loss and heat transfer, but also have structural properties. In accordance with a highly advantageous feature, it has been found that adhesive tape 60 can be used in combination with the structural insulating materials of the insulating box 40 to form a container which has a combination of light weight and rigidity highly desirable for use with chilled items, particularly chilled foodstuffs. At least one layer of tape may be wrapped around the insulating box 40. As shown in FIGS. 3 and 8, one layer of tape 60 is covers an edge between the side walls 41-44 and the bottom wall 45. Two more layers of tape 60 are wrapped around the insulating box 40. These layers of tape provide enhanced structural rigidity, allowing the thickness of the walls to be reduced. For example, the use of tape may allow reduction in the thickness of the insulation box from at least 3 inches to about two inches. An example of a suitable tape for use with thermal storage containers disclosed herein is Scotch Bi-Directional Filament Tape manufactured by 3M of Minnesota.

Preferably the insulating box 40 walls 41-46 in a closed position (with lid wall on side walls 41-44 as shown in FIG. 8) cooperate with the gasket 49 to define an interior space. The inner box 50 is entirely, snugly surrounded by the insulating box, and is positioned in the interior space. More specifically, the inner box is entirely surrounded by walls 41-46, gasket 49 and a very thin layer of adhesive 48. No additional reinforcing frame members (which could transmit heat) are used which could transmit heat from outside the insulating box to the interior space. Other multi-sided geometries for use as the insulating box beyond the six sided rectangular solid shown in the drawings will be readily apparent to those skilled in the art given the benefit of this disclosure, and include cubes, spheres, etc. Also, different shaped boxes may be used in combination, if desired.

As noted above, the thermal storage containers 10 disclosed herein are designed to hold items chilled to at least a commercially desired temperature for a predetermined period of time. As a representative example, a thermal storage container may have the insulating box walls 41-46 have an R value of 5/inch, the walls each have a thickness of at least 2 inches, and three wraps of tape 60 are positioned around the walls, with one wrap covering the meeting between the side walls 41-44 and the bottom wall 45. When used in combination with the nested inner box, outer box and outer carton formed as corrugated cardboard as discussed above, it has been found this allows shipment of food or other perishables initially chilled to minus 10° F. to keep the food chilled to below freezing (32° F.) for at least 48 hours. This advantageously allows time for shipment all across the country without the need for dry ice or frozen gel packs.

The embodiments discussed were chosen and described to provide the best illustration of the principles of the invention and its practical application to thereby enable one of ordinary skill in the art to use the invention in various embodiments and with various modifications as are suited to the particular use contemplated. For example, the thermal storage container can be used to hold the heat of warm items for extended periods of time. All such modifications and variations are within the scope of the invention as determined by the appended claims when interpreted in accordance with the breadth to which they are fairly, legally, and equitably entitled.

1. A thermal storage container for storing items at or below a desired temperature for a predetermined period of time comprising, in combination:
an outer carton;
an outer box positioned within the outer carton;
an insulating box positioned within the outer box, wherein the insulating box has at least one wall having a thickness; and
an inner box;
wherein the insulating box surrounds the inner box, and the insulating box has an R value of at least 4 per inch of thickness of wall.

2. The thermal storage container of claim 1 wherein the insulating box is removable from the outer box, and the inner box is removable from the insulating box.

3. The thermal storage container of claim 1 wherein an interference fit exists between the inner box and the insulating box, the insulating box and the outer box, and the outer box and the outer carton.

4. The thermal storage container of clam 1 wherein the inner box and outer box are cascaded.

5. The thermal storage container of claim 1 further comprising at least one layer of tape wrapped around the insulating box.

6. The thermal storage container of claim 1 wherein the predetermined period of time is at least 24 hours.

7. The thermal storage container of claim 1 wherein the predetermined period of time is at least 48 hours and the desired temperature is 32° F.

8. A thermal storage container for storing items at or below a desired temperature for a predetermined period of time comprising, in combination:
an outer carton;
an outer box nested within the outer carton;
an insulating box nested within the outer box, wherein the insulating box has at least one wall having a thickness; and
an inner box nested within the insulating box;
wherein an interference fit exists between at least one of the inner box and the insulating box, the insulating box and the outer box, and the outer box and the outer carton.

9. The thermal storage container of claim 8 wherein the insulating box further comprises four side walls, and a bottom wall glued together, and a removable lid wall which provides access to the inner box.

10. The thermal storage container of claim 9 further comprising a gasket positioned between the side walls and the lid wall.

11. The thermal storage container of claim 10 wherein the gasket comprises a medium density polyvinylchloride attached to the side walls.

12. The thermal storage container of claim 9 wherein the lid wall comprises two pieces adhesively bound to one another.

13. The thermal storage container of claim 8 wherein at least one of the outer carton, outer box and inner box have four flaps which cooperate to form a top, and two of the flaps are formed with a notch.

14. The thermal storage container of claim 8 wherein the at least one wall comprises four side walls, a lid wall and a bottom wall, and the wall thickness is at least two inches.

15. A thermal storage container for storing items at or below a desired temperature for a predetermined period of time comprising, in combination:
an outer box;
an insulating box positioned within the outer box, wherein the insulating box has four side walls, a bottom wall which meets the four side walls at an edge, and a lid wall, with each wall having a thickness of less than three inches;
at least one layer of tape wrapped around the insulating box, covering the edge between side walls and the bottom wall; and
an inner box;
wherein the insulating box surrounds the inner box, and the insulating box has an R value of at least 4 per inch of thickness of wall.

16. The thermal storage container of claim 14 further comprising a hot melt adhesive adhering the side walls to each other and to the bottom wall.

17. The thermal storage container of claim 14 wherein the inner box is nested in the insulating box and the insulating box is nested in the outer box.
